(19) United States
(12) Patent Application Publication
(10) Pub. No.: US 2013/0117266 A1
(43) Pub. Date: May 9, 2013

(54) GEO-FENCE BASED ON GEO-TAGGED MEDIA

(71) Applicants: Saar Yahalom, Tel Aviv (IL); Elinor Axelrod, Tel Aviv (IL)

(72) Inventors: Saar Yahalom, Tel Aviv (IL); Elinor Axelrod, Tel Aviv (IL)

(73) Assignee: MICROSOFT CORPORATION, Redmond, WA (US)

(21) Appl. No.: 13/293,095

(22) Filed: Nov. 9, 2011

(51) Int. Cl. G06F 17/30

(52) U.S. Cl. 707/737; 707/736; 707/E17.014; 707/E17.018

(57) ABSTRACT

Architecture that creates a geo-fence based on geo-tagged item (e.g., a photo. The geo-tagged item can be used to share virtual boundaries, such as geo-fences, between users via conventional methods (e.g., email) for sharing digital media. An extraction component that extracts geolocation information (e.g., latitude and longitude coordinates, altitude, bearing, distance, place names, etc.) of a geo-tagged item. The geolocation information can be related to a geographical location at which the item is geo-tagged. A boundary component then creates a virtual boundary (e.g., geo-fence) in association with the geographical location and based on the geolocation information. Thereafter, the virtual boundary is triggered when the user crosses (e.g., engages, intersects) the boundary and the attached action is triggered. The geo-tagged item can be shared with another user, which when is processed, creates a virtual boundary for that other user.

### BACKGROUND

Geo-tagging is the process of adding identifying geographic metadata (e.g., latitude and longitude coordinates) from a geolocation system such as GPS (global positioning system) to media. Cameras and mobile devices (e.g., mobile phones) are capable of taking geo-tagged photos that include the geographical coordinates of the physical location where the photo was taken. Additionally, geo-fences are becoming more popular as a mechanism for initiating reminders relative to certain geographic locations. However, in order to create a geo-fence based on the photo location existing techniques must use several separate tools--there is no single-step solution to create a geo-fence from a geo-tagged photo.

### SUMMARY

The following presents a simplified summary in order to provide a basic understanding of some novel embodiments described herein. This summary is not an extensive overview, and it is not intended to identify key/critical elements or to delineate the scope thereof Its sole purpose is to present some concepts in a simplified form as a prelude to the more detailed description that is presented later.

The disclosed architecture creates a geo-fence based on geo-tagged item (e.g., a photo, website, document, messages, feeds, etc.) in a single step. Moreover, the geo-tagged item can be used to share virtual boundaries, such as geo-fences, between users via conventional methods (e.g., email) for sharing digital media.

Generally, the architecture can include an extraction component that extracts geolocation information (e.g., latitude and longitude coordinates, altitude, bearing, distance, place names, etc.) of a geo-tagged item. The geolocation information can be related to a geographical location at which the item is geo-tagged. A boundary component creates a virtual boundary (e.g., geo-fence) in association with the geographical location and based on the geolocation information.

In the context of photos, a geo-tagging capable camera or phone can be used to take a photo in a specific geographic location (e.g., a photo of a meeting place). The location information is then extracted from the photo. A geo-fence is defined for the extracted geographic location. For example, a circle (or other geometric construction) with a diameter of X meters is created around the extracted geographic location. An action (e.g., reminder, notification, etc.) is attached to the created geo-fence. Actions are metadata that are attached to the geo-fence description. The geo-fence can then be saved to a persistent storage (e.g., locally on the device and/or on an external global database). Thereafter, the geo-fence is triggered when the user crosses (e.g., engages, intersects) the geo-fence and the attached action is triggered (e.g., a reminder is transmitted and presented to the user device that triggered the geo-fence or a device different than the device that triggered the geo-fence).

The photo can be shared with another user using email (or any other sharing method). The user receiving the geo-tagged photo can then create a geo-fence using the above technique. Optionally, one or more geo-fence actions to be performed can be embedded in the photo metadata (e.g., using exchangeable image file format (EXIF)). Optionally, the embedded geo-fence action can be attached to the created geo-fence for the user that took the photo and/or for another user the received and processed the photo. The photo metadata can also be encrypted/decrypted for improved security.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system that facilitates the sharing and utilization of the geo-tagged item.

FIG. 3 illustrates the action as embedded in the geo-tagged item.

FIG. 4 illustrates a system that further employs a security component for authorized and secure handling of user information.

FIG. 5 illustrates a method in accordance with the disclosed architecture.

FIG. 6 illustrates further aspects of the method of FIG. 6.

FIG. 7 illustrates an alternative method in accordance with the disclosed architecture.

FIG. 8 illustrates further aspects of the method of FIG. 7.

FIG. 9 illustrates a block diagram of a computing system that executes creation of a geo-fence based on a geo-tagged item in accordance with the disclosed architecture.

### DETAILED DESCRIPTION

A geo-fence is a virtual perimeter or boundary created in association with a geographic location. The geo-fence can be generated dynamically (e.g., a radius circumscribing a store), or can be a predefined set of boundaries. When the location-aware device of a user operating in combination with a location-based service crosses or engages the geo-fence, notification can be generated and sent (e.g., by phone call, email, etc.) to the user.

The disclosed architecture facilitates the creation of a geo-fence based on a geo-tagged item such as a photo in a single step. Further, geo-tagged items can be used to share geo-fences between people using all the methods currently employed to share digital photos. By extracting the geolocation information from the geo-tagged item, a geo-fence can be created for that location.

Reference is now made to the drawings, wherein like reference numerals are used to refer to like elements throughout. In the following description, for purposes of explanation, numerous specific details are set forth in order to provide a thorough understanding thereof It may be evident, however, that the novel embodiments can be practiced without these specific details. In other instances, well known structures and devices are shown in block diagram form in order to facilitate a description thereof The intention is to cover all modifications, equivalents, and alternatives falling within the spirit and scope of the claimed subject matter.

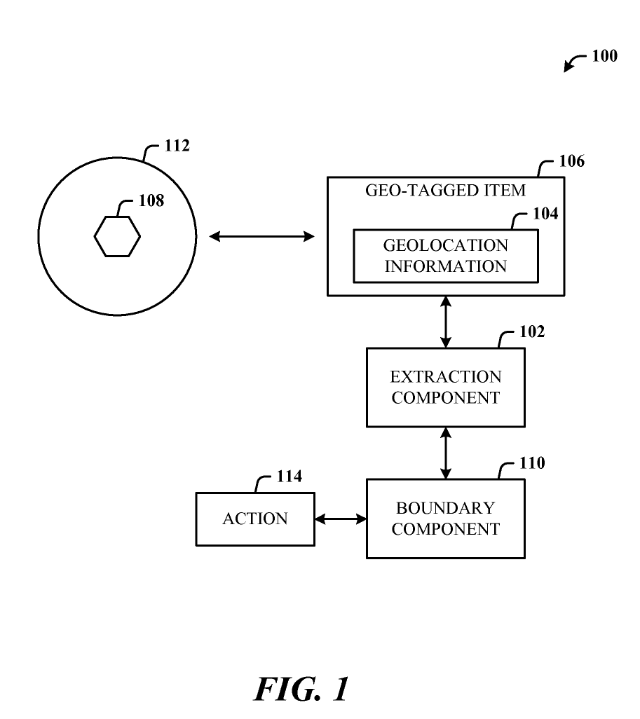

FIG. 1 illustrates a system 100 in accordance with the disclosed architecture. The system 100 includes an extraction component 102 that extracts geolocation information 104 of a geo-tagged item 106. The geolocation information 104 related to a geographical location 108 at which the item 106 is geo-tagged. A boundary component 110 creates a virtual boundary 112 in association with the geographical location 108 based on the geolocation information 104.

The geo-tagged item 106 can be a photo. The virtual boundary 112 (the boundary information) is stored in association with a user identifier of a user. The boundary component 110 initiates an action 114 in association with the user in response to engagement of the virtual boundary 112 by a location-aware device of the user.

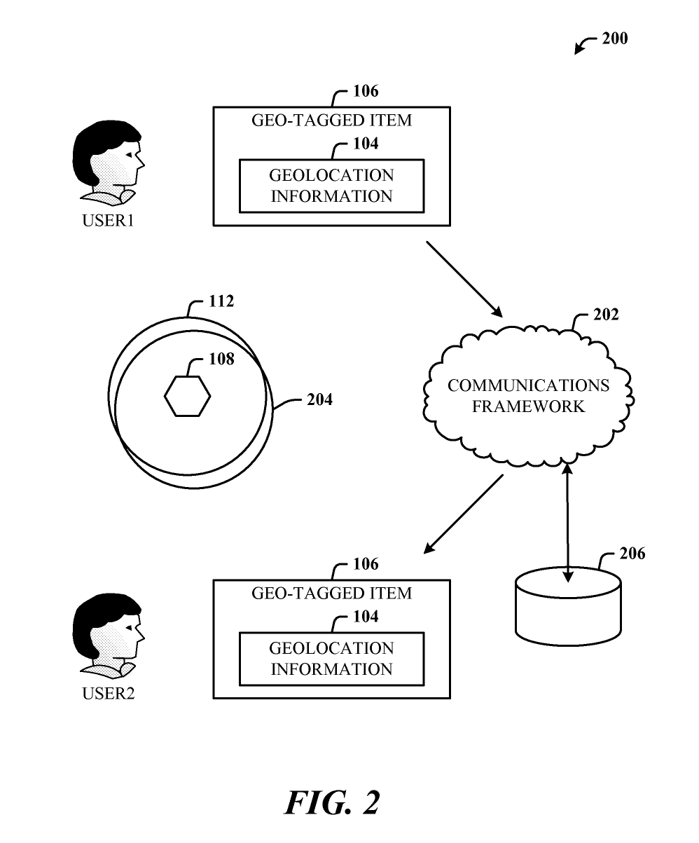

FIG. 2 illustrates a system 200 that facilitates the sharing and utilization of the geo-tagged item 106. In operation, after the virtual boundary 112 (e.g., geo-fence) has been created for a first user (User1), based on extraction of the geolocation information 104 of the geo-tagged item 106, the first user sends the item 106 through a communications framework 202 (e.g., email) to a second user (User2). A system and/or device of the second user can then receive and extract the geolocation information 104 from the geo-tagged item 106, and then generate the same or a different virtual boundary 204 (offset for clarity) for the second user. A storage system 206 is provided to store the relationships of the first user, geo-tagged item 106, geolocation information 104, and the virtual boundary 112, as well as the relationships of the second user, geo-tagged item 106, geolocation information 104, and the virtual boundary 204. The virtual boundary 112 is then associated with the other (second) user.

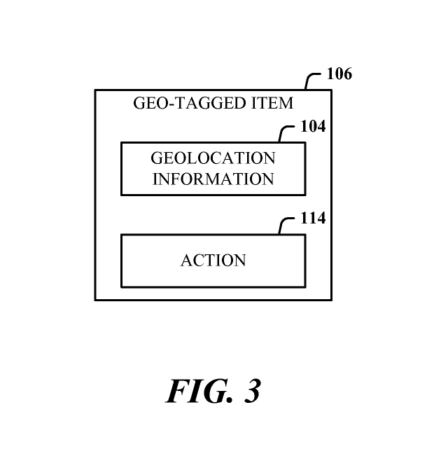

FIG. 3 illustrates the action 114 as embedded in the geo-tagged item 106. The geo-tagged item 106 can be a photo having embedded action information. The embedded action 114 is processed by device of a receiving user (the second user) and activated if the receiving user is detected to have engaged the virtual boundary. The embedded action 114 is processed by device of a receiving (second) user and associated with a virtual boundary created for the receiving user. The action can be a notification (e.g., reminder) sent to a user device.

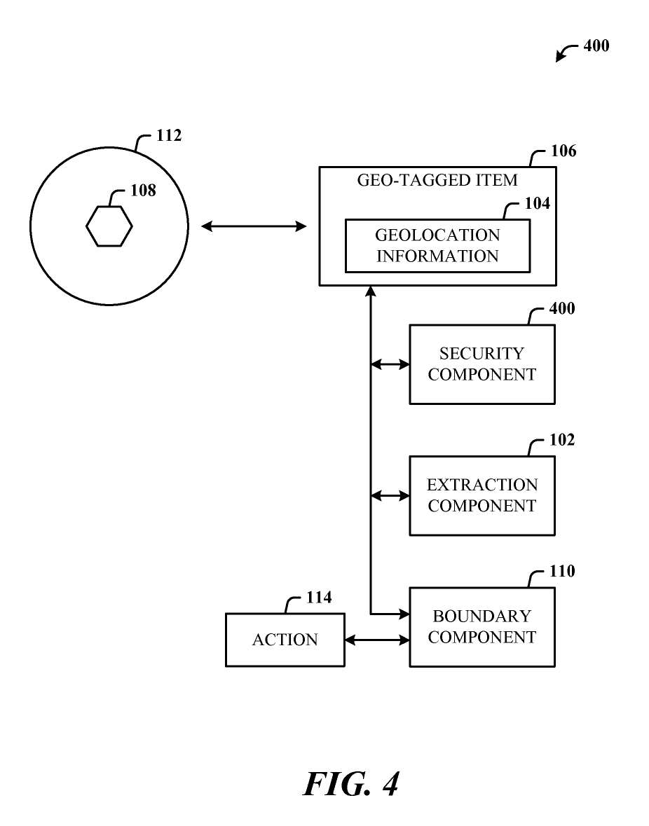

FIG. 4 illustrates a system 400 that further employs a security component 402 for authorized and secure handling of user information. The security component 402 enables a user to opt-in or opt-out of exposing the geolocation information, an action, and/or any relationship of this information to the user.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

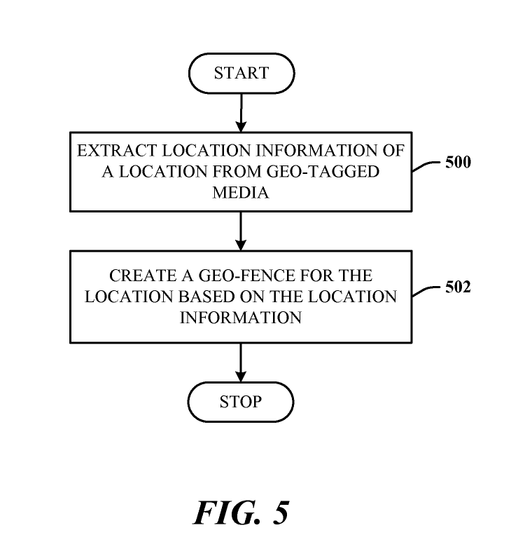

FIG. 5 illustrates a method in accordance with the disclosed architecture. At 500, location information of a location is extracted from geo-tagged media (e.g., a photo). At 502, a geo-fence is created for the location based on the location information.

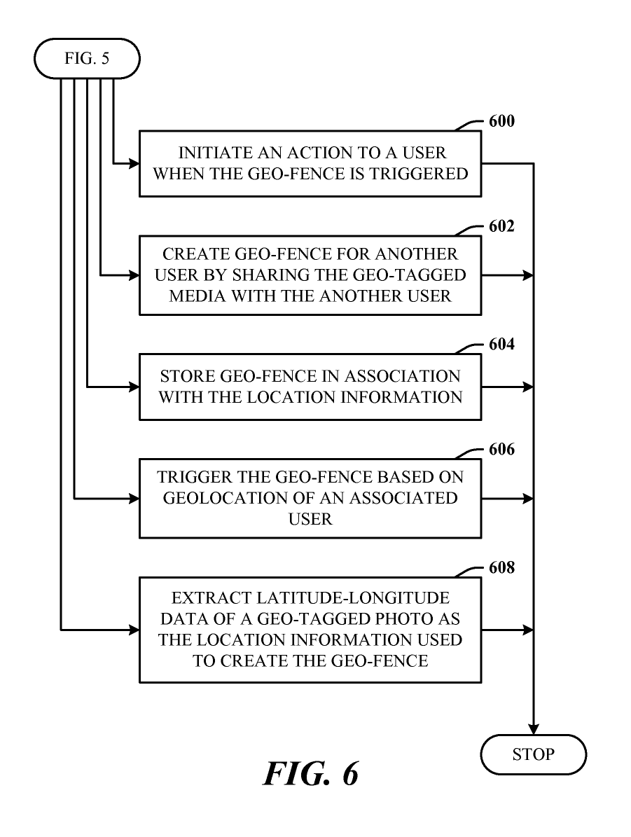

FIG. 6 illustrates further aspects of the method of FIG. 6. Note that the flow indicates that each block can represent a step that can be included, separately or in combination with other blocks, as additional aspects of the method represented by the flow chart of FIG. 5. At 600, an action is initiated to a user when the geo-fence is triggered. At 602, the geo-fence is created for another user by sharing the geo-tagged media with the another user. At 604, the geo-fence is stored in association with the location information (e.g., locally or in an external global database). At 606, the geo-fence is triggered based on geolocation of an associated user. At 608, latitude-longitude data of a geo-tagged photo is extracted as the location information used to create the geo-fence.

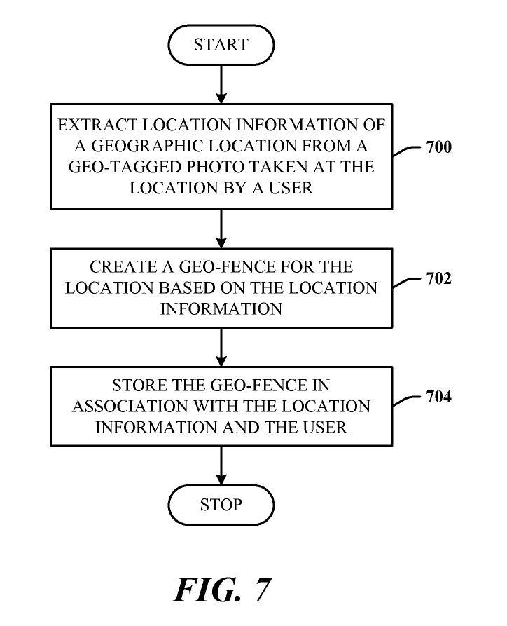

FIG. 7 illustrates an alternative method in accordance with the disclosed architecture. At 700, location information of a geographic location is extracted from a geo-tagged photo taken at the location by a user. At 702, a geo-fence is created for the location based on the location information. At 704, the geo-fence is stored in association with the location information and the user.

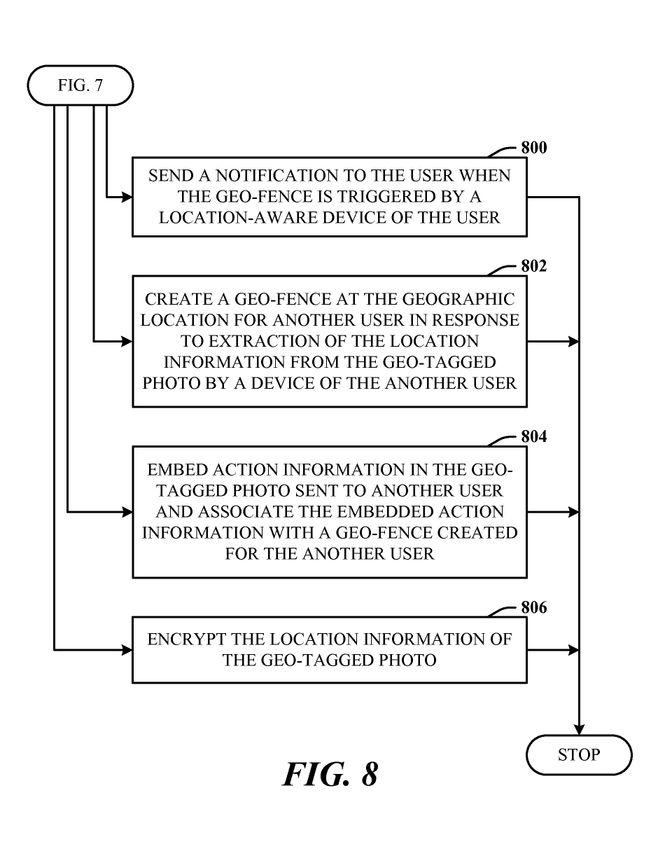

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, a notification is sent to the user when the geo-fence is triggered by a location-aware device of the user. At 802, a geo-fence is created at the geographic location for another user in response to extraction of the location information from the geo-tagged photo by a device of the another user. At 804, action information is embedded in the geo-tagged photo sent to another user and associating the embedded action information with a geo-fence created for the another user. At 806, the location information of the geo-tagged photo is encrypted.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

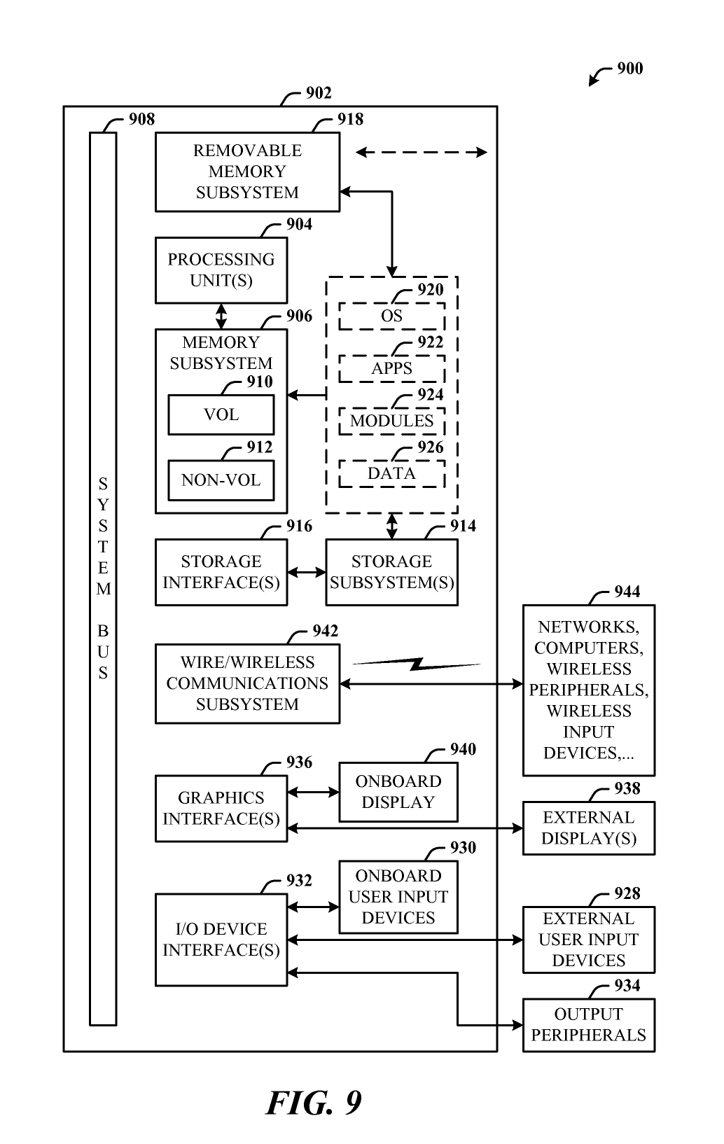

Referring now to FIG. 9, there is illustrated a block diagram of a computing system 900 that executes creation of a geo-fence based on a geo-tagged item in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a computer-readable storage such as a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include computer-readable storage (physical storage media) such as a volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 (physical storage media) can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include entities and components of the system 100 of FIG. 1, entities and components of the system 200 of FIG. 2, the embedded capabilities of the geo-tagged item of FIG. 3, the security aspect of system 400 of FIG. 4, and the methods represented by the flowcharts of FIGS. 5-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 902 and includes volatile and non-volatile internal and/or external media that is removable or non-removable. For the computer 902, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an extraction component that extracts geolocation information of a geo-tagged item, the geolocation information related to a geographical location at which the item is geo-tagged;
a boundary component that creates a virtual boundary in association with the geographical location based on the geolocation information; and
a processor that executes computer-executable instructions associated with at least one of the extraction component or the boundary component.

2. The system of claim 1, wherein the geo-tagged item is a photo.

3. The system of claim 1, wherein the virtual boundary is stored in association with a user identifier of a user.

4. The system of claim 3, wherein the boundary component initiates an action in association with the user in response to engagement of the virtual boundary by a location-aware device of the user.

5. The system of claim 1, wherein the virtual boundary is shared with another user via sharing of access to the geo-tagged item, the virtual boundary then associated with the another user.

6. The system of claim 1, wherein the geo-tagged item is a photo having embedded action information.

7. The system of claim 6, wherein the embedded action information is processed by device of a receiving user and activated if the receiving user is detected to have engaged the virtual boundary.

8. The system of claim 6, wherein the embedded action information is processed by device of a receiving user and associated with a virtual boundary created for the receiving user.

9. The system of claim 1, wherein the action is a notification sent to a user device.

10. A method, comprising acts of:
extracting location information of a location from geo-tagged media;
creating a geo-fence for the location based on the location information; and
utilizing a processor that executes instructions stored in memory to perform at least one of the acts of extracting or creating.

11. The method of claim 10, further comprising initiating an action to a user when the geo-fence is triggered.

12. The method of claim 10, further comprising creating the geo-fence for another user by sharing the geo-tagged media with the another user.

13. The method of claim 10, further comprising storing the geo-fence in association with the location information.

14. The method of claim 10, further comprising triggering the geo-fence based on geolocation of an associated user.

15. The method of claim 10, further comprising extracting latitude-longitude data of a geo-tagged photo as the location information used to create the geo-fence.

16. A method, comprising acts of:
extracting location information of a geographic location from a geo-tagged photo taken at the location by a user;
creating a geo-fence for the location based on the location information;
storing the geo-fence in association with the location information and the user; and
utilizing a processor that executes instructions stored in memory to perform at least one of the acts of extracting or creating.

17. The method of claim 16, further comprising sending a notification to the user when the geo-fence is triggered by a location-aware device of the user.

18. The method of claim 16, further comprising creating a geo-fence at the geographic location for another user in response to extraction of the location information from the geo-tagged photo by a device of the another user.

19. The method of claim 16, further comprising embedding action information in the geo-tagged photo sent to another user and associating the embedded action information with a geo-fence created for the another user.

20. The method of claim 16, further comprising encrypting the location information of the geo-tagged photo.
